(19) United States
(12) Patent Application Publication
(10) Pub. No.: US 2003/0133186 A1
(43) Pub. Date: Jul. 17, 2003

(54) Optical switching system and apparatus with integral covering lens

(76) Inventor: Yakov Reznichenko, Newton, MA (US)

Correspondence Address: BROMBERG & SUNSTEIN LLP, 125 SUMMER STREET, BOSTON, MA, 02110-1618, US

(21) Appl. No.: 10/047,566

(22) Filed: Jan. 15, 2002

(51) Int. Cl. G02B 17/00

(52) U.S. Cl. 359/366; 359/365; 359/727; 359/856

(57) ABSTRACT

An optical switching system and apparatus includes a plurality of micro-machined mirrors and a covering lens for adjusting the optical field of at least one of the plurality of micro-machined mirrors. The covering lens has a positive focal length.

### FIELD OF THE INVENTION

The present invention relates generally to optical switching, and more particularly to an optical switching system and apparatus having an integral covering lens for adjusting the optical field of at least one mirror.

### BACKGROUND OF THE INVENTION

An optical switch can be formed using two arrays of micro-machined mirrors, which are often referred to as Micro Electromechanical System (MEMS) arrays. Each MEMS array typically includes N mirrors. The MEMS arrays are typically positioned opposite each other. Such an optical switch is generally capable of switching optical signals from any of N input fibers to any of N output fibers.

In order to switch an optical signal from a selected input fiber to a selected output fiber, the optical signal is directed from the selected input fiber to a selected mirror on one MEMS array, which reflects the optical signal to a selected mirror on the other MEMS array, which reflects the optical signal toward the selected output fiber. An input lens array is used to direct optical signals from the input fibers to the first MEMS array. An output lens array is used to direct optical signals from the second MEMS array to the output fibers.

One problem in such an optical switch is that the angular efficiency of the MEMS mirrors is not uniform across the entire field of view. Specifically, the angular efficiency is better in the middle of the MEMS array than toward the edges of the MEMS array.

### SUMMARY OF THE INVENTION

In accordance with one aspect of the present invention, a MEMS array includes a covering lens that adjusts the optical field of at least one mirror.

In accordance with another aspect of the present invention, an optical switch includes at least one MEMS array having a covering lens that adjusts the optical field of at least one mirror.

In accordance with yet another aspect of the present invention, an apparatus includes a plurality of micro-machined mirrors and a covering lens disposed over the plurality of mirrors for adjusting an optical field of at least one of the plurality of micro-machined mirrors. The covering lens has a positive focal length. The covering lens includes a first surface facing toward the plurality of micro-machined mirrors and a second surface facing away from the plurality of micro-machined mirrors. The first surface may be substantially flat and the second surface may be substantially convex. The first surface may be substantially convex and the second surface may be substantially flat. The first surface may be substantially concave and the second surface may be substantially convex with a smaller radius than the concave surface.

In accordance with still another aspect of the invention, and optical switching system includes a first mirror apparatus having a plurality of micro-machined mirrors and a second mirror apparatus having a plurality of micro-machined mirrors. The first mirror apparatus is operably coupled to reflect an optical signal toward a selected mirror of the second mirror apparatus. At least one of the first mirror apparatus and the second mirror apparatus includes a covering lens for adjusting an optical field of at least one of its plurality of micro-machined mirrors. The covering lens has a positive focal length. The covering lens includes a first surface facing toward the plurality of micro-machined mirrors and a second surface facing away from the plurality of micro-machined mirrors. The first surface may be substantially flat and the second surface may be substantially convex. The first surface may be substantially convex and the second surface may be substantially flat. The first surface may be substantially concave and the second surface may be substantially convex with a smaller radius than the concave surface.

In accordance with still another aspect of the invention, an optical switching apparatus includes a plurality of micro-machined mirrors and means for adjusting an optical field of at least one of the plurality of micro-machined mirrors.

### BRIEF DESCRIPTION OF THE DRAWINGS

In the accompanying drawings:

FIG. 1 is a block diagram showing an exemplary optical switch as known in the art;

FIG. 2 is a block diagram showing a cross-sectional view of an exemplary MEMS array as known in the art;

FIG. 3 is a block diagram showing the optical field of a mirror in the middle of the MEMS array as known in the art;

FIG. 4 is a block diagram showing the optical field of a mirror at the edge of the MEMS array as known in the art;

FIG. 5 is a block diagram showing an exemplary optical switch that includes additional optics to improve angular efficiency and uniformity as known in the art;

FIG. 6 is a block diagram showing an exemplary MEMS array including a covering lens with a substantially flat side facing the mirrors and a substantially convex side facing away from the mirrors in accordance with an embodiment of the present invention;

FIG. 7 is a block diagram showing an exemplary MEMS array including a covering lens with a substantially concave side facing the mirrors and a substantially convex side facing away from the mirrors in accordance with an embodiment of the present invention;

FIG. 8 is a block diagram showing an exemplary MEMS array including a covering lens with a substantially convex side facing the mirrors and a substantially flat side facing away from the mirrors in accordance with an embodiment of the present invention;

FIG. 9 is a block diagram showing how an exemplary optical switch adjusts the optical field of at least one of the plurality of micro-machined mirrors in accordance with an embodiment of the present invention; and

FIG. 10 is a block diagram showing the relevant components of an exemplary optical switch in accordance with an embodiment of the present invention.

### DETAILED DESCRIPTION OF A PREFERRED EMBODIMENT

In an embodiment of the present invention, a MEMS array is covered by a lens that increases the angular efficiency toward the edges of the MEMS array and makes the angular efficiency more uniform across the entire field of view. The covering lens typically has a positive focal length. The focal length of the covered MEMS array (including the covering lens and mirrors) is typically configured so as to be equal to the distance between the two MEMS arrays in an optical switch.

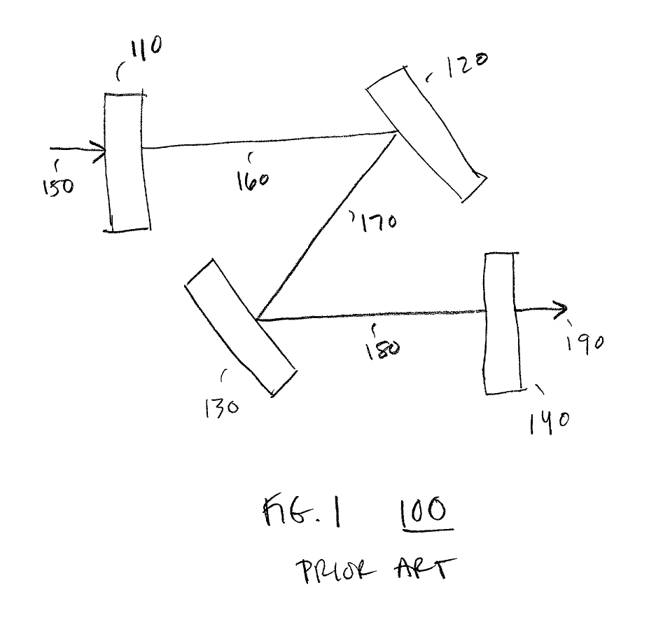

FIG. 1 is a block diagram showing an exemplary optical switch 100 as known in the art. Among other things, the optical switch 100 includes an input lens array 110, a first MEMS array 120, a second MEMS array 130, and an output lens array 140. Within the optical switch 100, the first MEMS array 120 and the second MEMS array 130 are typically aligned such that each mirror of the first MEMS array 120 is directly across from a corresponding mirror of the second MEMS array 130. The input lens array 110 is typically positioned so as to direct input signals from each of N input fibers to a corresponding mirror of the first MEMS array 120. The output lens array 140 is typically positioned so as to direct output signals from each mirror of the second MEMS array 130 to a corresponding output fiber.

An input optical signal 150 from an input fiber is directed by the input lens array 160 toward a corresponding mirror of the first MEMS array 120, as shown by the line 160. The mirror of the first MEMS array 120 reflects the signal 160 toward a selected mirror of the second MEMS array 130 corresponding to a selected output fiber, as shown by the line 170. The selected mirror of the second MEMS array 130 reflects the signal 170 to the output lens array 140, as shown by the line 180. The output lens array 140 directs the signal 180 toward the corresponding output fiber, as shown by the line 190. It should be noted that the input lens array 110, first MEMS array 120, second MEMS array 130, and output lens array 140 are typically separated in space and are typically not coupled through a tangible optical medium (such as an optical fiber), and therefore such an optical switch is sometimes referred to as a “free space” optical switch.

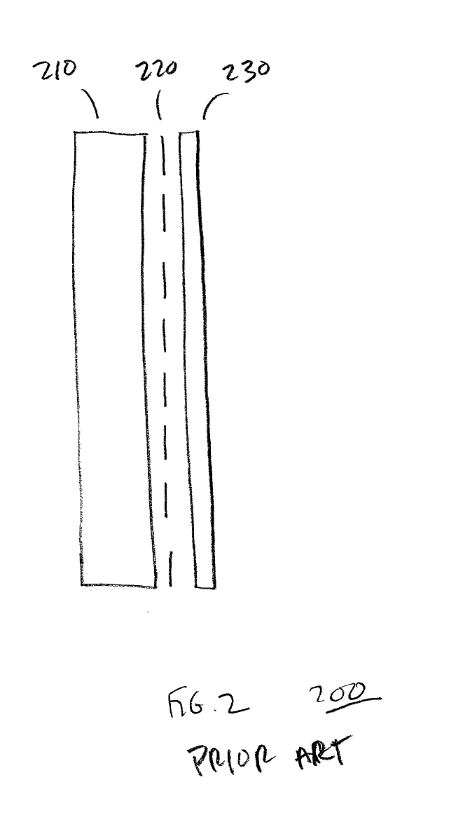

FIG. 2 is a block diagram showing a cross-sectional view of an exemplary MEMS array 200 as known in the art. Among other things, the MEMS array 200 includes a substrate 210, a number of mirrors 220 formed on or from the substrate 210, and a cover 230. The mirrors 220 are typically suspended from the substrate 210 on minute tethers (not shown for convenience) that allow the mirrors to move through some range of motion. The position of each mirror 220 is typically controlled electronically, for example, using electrostatic forces. The cover 230 protects the extremely fragile mirrors 220 and also enables optical signals to pass to and from the mirrors 220.

One problem the optical switch 100 is that the angular efficiency of the MEMS mirrors is not uniform across the entire field of view. Specifically, the angular efficiency is better in the middle of the MEMS array than toward the edges of the MEMS array.

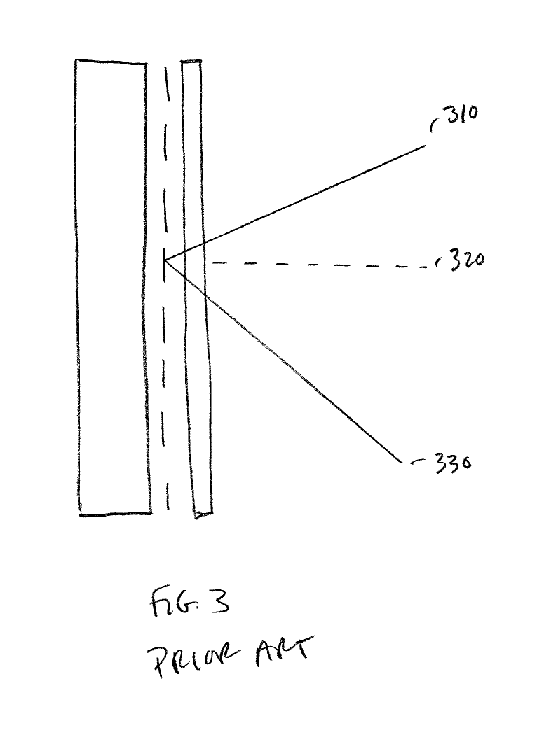

FIG. 3 is a block diagram showing the optical field of a mirror in the middle of the MEMS array 200 as known in the art. The dashed line 320 represents the nominal position of the middle mirror. The line 310 represents the position of the middle mirror at one extreme. The line 330 represents the position of the middle mirror at the other extreme. When used in an optical switch, such as the optical switch 100, the middle mirror is usable through substantially its entire range of motion.

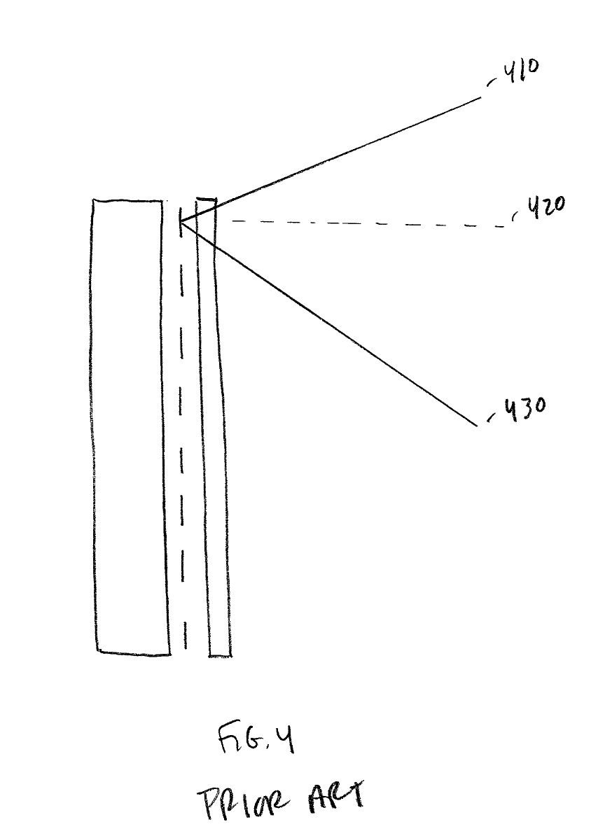

FIG. 4 is a block diagram showing the optical field of a mirror at the edge of the MEMS array 200 as known in the art. The dashed line 420 represents the nominal position of the edge mirror. The line 410 represents the position of the edge mirror at one extreme. The line 430 represents the position of the edge mirror at the other extreme. When used in an optical switch, such as the optical switch 100, the edge mirror is not usable through substantially its entire range of motion, but is instead only usable through a limited range of motion because substantially half of its range of motion places the edge mirror in a position that is outside of the optical field of the other optical components of the optical switch 100. This not only limits the efficiency of the optical switch 100, but also makes it more difficult to control the mirrors.

In a typical MEMS array 200, the cover 230 is substantially flat on both sides and provides substantially no optical power. Thus, the cover 230 does not substantially affect the optical field of any mirror of the MEMS array 200.

Angular efficiency and uniformity can be improved by using additional optics between the various optical switch components, and in particular between the two MEMS arrays of the optical switch 100.

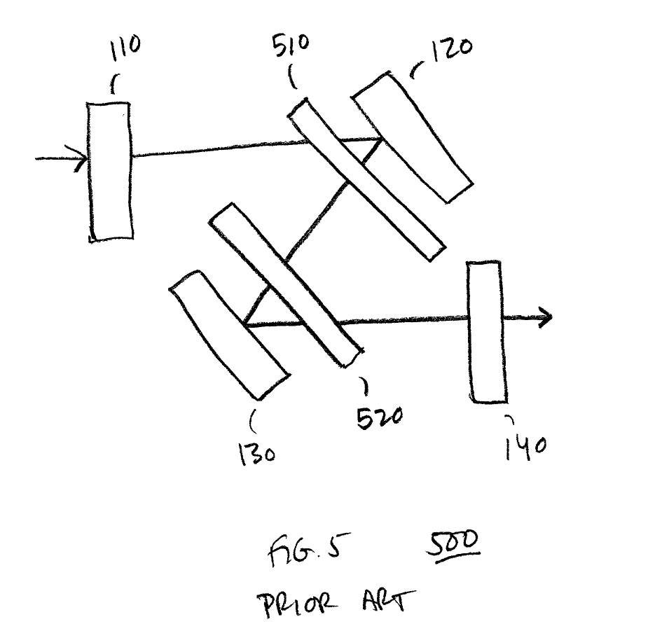

FIG. 5 is a block diagram showing an exemplary optical switch 500 that includes additional optics to improve angular efficiency and uniformity as known in the art. In this example, additional lenses 510 and 520 are placed between the input lens array 110, the first MEMS array 120, the second MEMS array 130, and the output lens array 140.

Although the additional optics improve angular efficiency and uniformity, the additional optics add substantial cost and complexity to the optical switch. For example, the additional lenses must be precisely machined and positioned within the optical switch.

In an embodiment of the present invention, angular efficiency and uniformity are improved by forming the cover 230 into a lens that effectively increases the angular efficiency toward the edges of the MEMS array 200 and makes the angular efficiency more uniform across the entire optical field. The covering lens is shaped so as to adjust the optical field of each mirror as needed to allow more of the optical field to be usable. Thus, the covering lens typically adjusts the optical field of mirrors near the edge of the MEMS array to a greater degree than it does for mirrors toward the middle of the MEMS array. It should be noted, however, that the covering lens is not limited to any particular shape. Thus, for example, the covering lens can be flat on one side and convex on the other or concave on one side and convex on the other (with the convex side having a smaller radius than the concave side).

In one exemplary embodiment of the present invention, the covering lens is substantially flat on the side facing the mirrors and is substantially convex on the side facing away from the mirrors. The focal length of the covering lens is roughly twice the distance between the two MEMS arrays.

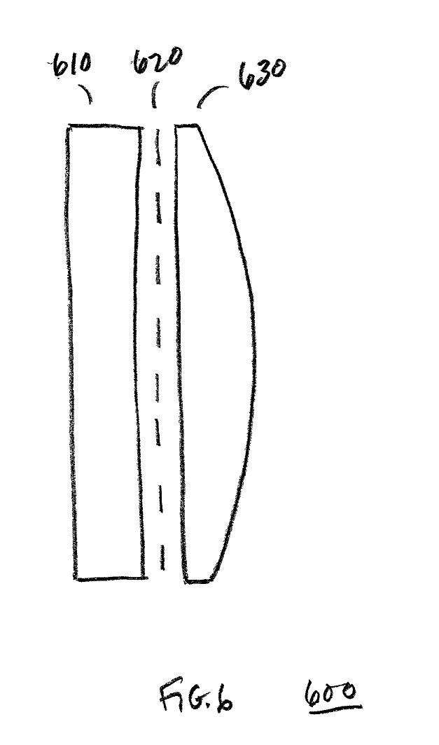

FIG. 6 is a block diagram showing an exemplary MEMS array 600 including a covering lens with a substantially flat side facing the mirrors and a substantially convex side facing away from the mirrors in accordance with an embodiment of the present invention. Among other things, the MEMS array 600 includes a substrate 610, a number of mirrors 620 formed on or from the substrate 610, and a covering lens 630. The substrate 610 and the mirrors 620 of the MEMS array 600 are substantially identical to the substrate 210 and mirrors 220 of the MEMS array 200 described above. The covering lens 630 is substantially flat on the side facing the mirrors 620 and is substantially convex on the side facing away from the mirrors 620. The focal length of the covering lens 630 is roughly twice the distance between the two MEMS arrays in an optical switch. As with the cover 230 of the MEMS array 200 described above, the covering lens 630 of the MEMS array 600 also protects the extremely fragile mirrors 620.

In another exemplary embodiment of the present invention, the covering lens is substantially concave on the side facing the mirrors and is substantially convex on the side facing away from the mirrors. The convex side has a smaller radius than the concave side. The focal length of the covering lens is roughly twice the distance between the two MEMS arrays.

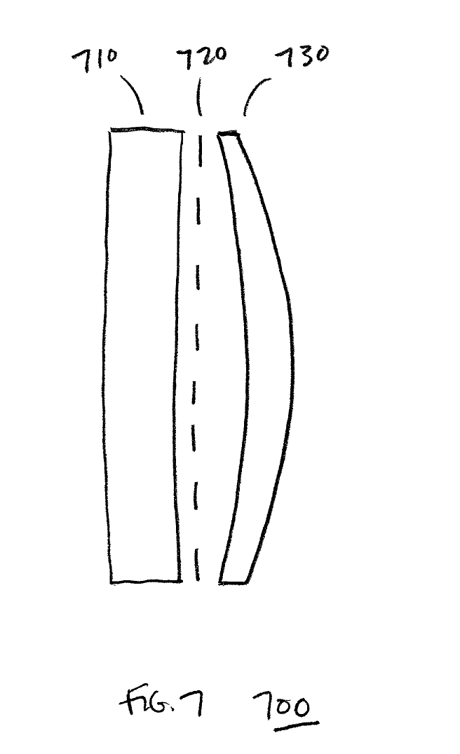

FIG. 7 is a block diagram showing an exemplary MEMS array 700 including a covering lens with a substantially concave side facing the mirrors and a substantially convex side facing away from the mirrors in accordance with an embodiment of the present invention. Among other things, the MEMS array 700 includes a substrate 710, a number of mirrors 720 formed on or from the substrate 710, and a covering lens 730. The substrate 710 and the mirrors 720 of the MEMS array 700 are substantially identical to the substrate 210 and mirrors 220 of the MEMS array 200 described above. The covering lens 730 is substantially concave on the side facing the mirrors 720 and is substantially convex on the side facing away from the mirrors 720. The convex side of the covering lens 730 has a smaller radius than the concave side of the covering lens 730. The focal length of the covering lens 730 is roughly twice the distance between the two MEMS arrays in an optical switch. As with the cover 230 of the MEMS array 200 described above, the covering lens 730 of the MEMS array 700 also protects the extremely fragile mirrors 720.

In yet another exemplary embodiment of the present invention, the covering lens is substantially convex on the side facing the mirrors and is substantially flat on the side facing away from the mirrors. The focal length of the covering lens is roughly twice the distance between the two MEMS arrays.

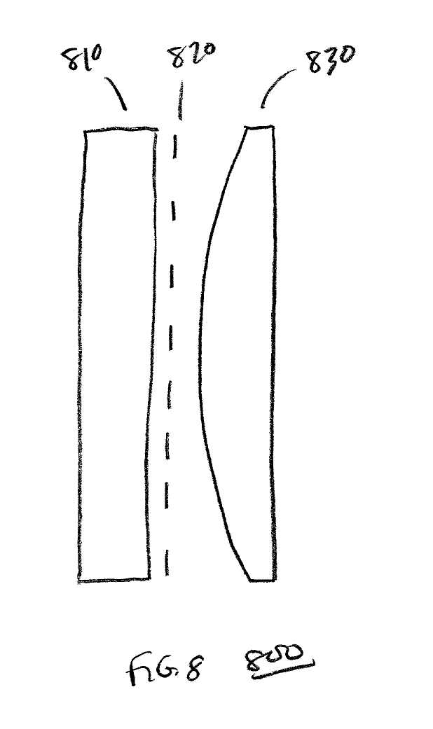

FIG. 8 is a block diagram showing an exemplary MEMS array 800 including a covering lens with a substantially convex side facing the mirrors and a substantially flat side facing away from the mirrors in accordance with an embodiment of the present invention. Among other things, the MEMS array 800 includes a substrate 810, a number of mirrors 820 formed on or from the substrate 810, and a covering lens 830. The substrate 810 and the mirrors 820 of the MEMS array 800 are substantially identical to the substrate 210 and mirrors 220 of the MEMS array 200 described above. The covering lens 830 is substantially convex on the side facing the mirrors 820 and is substantially flat on the side facing away from the mirrors 820. The focal length of the covering lens 830 is roughly twice the distance between the two MEMS arrays in an optical switch. As with the cover 230 of the MEMS array 200 described above, the covering lens 830 of the MEMS array 800 also protects the extremely fragile mirrors 820.

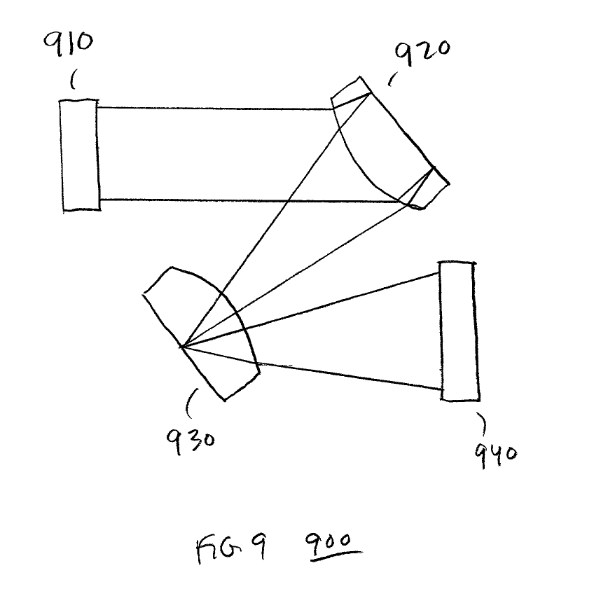

FIG. 9 is a block diagram showing how an exemplary optical switch 900 adjusts the optical field of at least one of the plurality of micro-machined mirrors in accordance with an embodiment of the present invention. Among other things, the optical switch 900 includes an input lens array 910, a first MEMS array 920 with covering lens, a second MEMS array 930 with covering lens, and an output lens array 940. Within the optical switch 900, the first MEMS array 920 and the second MEMS array 930 are typically aligned such that each mirror of the first MEMS array 920 is directly across from a corresponding mirror of the second MEMS array 930. The input lens array 910 is typically positioned so as to direct input signals from each of N input fibers to a corresponding mirror of the first MEMS array 920, taking into account any adjustments by the covering lens of the first MEMS array 920. The output lens array 940 is typically positioned so as to direct output signals from each mirror of the second MEMS array 930 to a corresponding output fiber, taking into account any adjustments by the covering lens of the second MEMS array 930. It should be noted that the first MEMS array 920 directs optical signals inward toward the second MEMS array 930.

It should be noted that the optical power of such a covering lens is effectively increased because an optical signal passes through the covering lens twice, once coming inward toward the mirror and once going outward from the mirror.

All movable mirrors on the MEMS arrays can be controlled independently in order to direct optical signals from the first MEMS array to the second MEMS array and from the second MEMS array to the output lenses. Specifically, the movable mirrors must be positioned at different angles in order to switch optical signals from the input fibers to the output fibers. Therefore, the optical switch typically includes control logic for controlling and positioning the movable mirrors. Among other things, the control logic determines the desired position for each movable mirror and generates the appropriate electronic signals to place each movable mirror in its desired position.

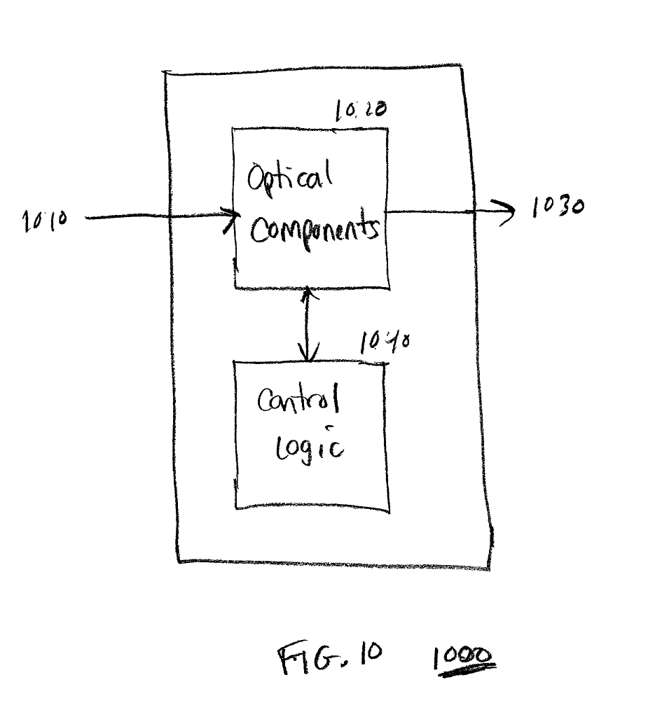

FIG. 10 is a block diagram showing the relevant components of an exemplary optical switch 1000. Among other things, the optical switch 1000 includes various optical components 1020 and control logic 1040. The optical components 1020 typically include various lenses and MEMS arrays for switching optical signals from input fibers 1010 to output fibers 1030. The control logic 1040 typically includes logic for determining the desired position for each movable mirror in the optical components 1020 and for sending appropriate electronic signals to the optical components 1020, and more specifically to the MEMS arrays, to place each movable mirror in its desired position.

The control logic 1040 may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the control logic 1040 may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the control logic 1040 may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

What is claimed is:

1. An apparatus comprising:
a plurality of movable mirrors; and
a covering lens disposed over the plurality of mirrors for adjusting an optical field of at least one of the plurality of mirrors.

2. The apparatus of claim 1, wherein the covering lens has a positive focal length.

3. The apparatus of claim 1, wherein the covering lens comprises:
a first surface facing toward the plurality of mirrors; and
a second surface facing away from the plurality of mirrors, wherein the first surface is substantially flat and the second surface is substantially convex.

4. The apparatus of claim 1, wherein the covering lens comprises:
a first surface facing toward the plurality of mirrors; and
a second surface facing away from the plurality of mirrors, wherein the first surface is substantially convex and the second surface is substantially flat.

5. The apparatus of claim 1, wherein the covering lens comprises:
a first surface facing toward the plurality of mirrors; and
a second surface facing away from the plurality of mirrors, wherein the first surface is substantially concave and the second surface is substantially convex with a smaller radius than the concave surface.

6. The apparatus of claim 1, wherein the plurality of mirrors are micro-machined mirrors.

7. An optical switching system comprising:
a first mirror apparatus having a plurality of movable mirrors; and
a second mirror apparatus having a plurality of movable mirrors, wherein the first mirror apparatus is operably coupled to reflect an optical signal toward a selected mirror of the second mirror apparatus, and wherein at least one of the first mirror apparatus and the second mirror apparatus includes a covering lens for adjusting an optical field of at least one of its plurality of mirrors.

8. The optical switching system of claim 7, wherein the covering lens has a positive focal length.

9. The optical switching system of claim 7, wherein the covering lens comprises:
a first surface facing toward the plurality of mirrors; and
a second surface facing away from the plurality of mirrors, wherein the first surface is substantially flat and the second surface is substantially convex.

10. The optical switching system of claim 7, wherein the covering lens comprises:
a first surface facing toward the plurality of mirrors; and
a second surface facing away from the plurality of mirrors, wherein the first surface is substantially convex and the second surface is substantially flat.

11. The optical switching system of claim 7, wherein the covering lens comprises:
a first surface facing toward the plurality of mirrors; and
a second surface facing away from the plurality of mirrors, wherein the first surface is substantially concave and the second surface is substantially convex with a smaller radius than the concave surface.

12. The optical switching system of claim 7, further comprising:
a plurality of input lenses operably coupled to direct a plurality of optical signals from a plurality of input fibers to the first mirror apparatus.

13. The optical switching system of claim 7, further comprising:
a plurality of output lenses operably coupled to receive a plurality of optical signals from the second mirror apparatus and direct the plurality of optical signals to a plurality of output fibers.

14. The optical switching system of claim 7, further comprising:
control logic operably coupled to determine a desired position for each movable mirror and to send control signals to the first mirror apparatus and the second mirror apparatus for setting each movable mirror to its desired position.

15. The optical switching system of claim 7, wherein the movable mirrors are micro-machined mirrors.

16. An optical switching apparatus comprising:
a plurality of micro-machined mirrors; and
means for adjusting an optical field of at least one of the plurality of micro-machined mirrors.
